(19) United States
(12) Patent Application Publication
(10) Pub. No.: US 2011/0229104 A1
(43) Pub. Date: Sep. 22, 2011

(54) System And Method For Recording and Playback Of Multimedia Content

(76) Inventor: Hank J. Hundemer, Bellevue, KY (US)

(21) Appl. No.: 12/910,775

(22) Filed: Oct. 22, 2010

Related U.S. Application Data
(60) Provisional application No. 61/254,192, filed on Oct. 22, 2009.

(51) Int. Cl. H04N 5/765

(52) U.S. Cl. 386/200; 386/E05.002

(57) ABSTRACT

A system and method employing an array of economical disk drives, each containing identical copies of the same multimedia content, for on-demand delivery to newsroom clients assigned to groups over respective communication channels. A Greeter Process parcels the multimedia content into data blocks having a size that is equal to the data field size of the drive's sectors. The Greeter Process then writes the parceled data block at least contemporaneously if not simultaneously to each of the disk drives, thereby optimizing the writing of the parceled content into the sectors of the disk drive and the subsequent reading of the parceled content from its sectors. Alternatively, the Greeter Process may parcel the multimedia content based upon inherent natural breaks such as anticipated periods of intensive computation. Upon demand, each newsroom client may read the desired multimedia content from its respective disk drive over its respective communication channel. Inasmuch as the multimedia content is identical on each disk drive, when any of the newsroom clients desires a particular multimedia file of, for example, a news event, each client receives an identical copy of that file of that news event over their respective communication channel from their respective disk drive.

### CROSS-REFERENCE TO RELATED APPLICATIONS

This application claims the benefit of the provisional patent application, Ser. No. 61/254,192 filed Oct. 22, 2009, the disclosure of which is hereby incorporated by reference herein.

### BACKGROUND OF THE INVENTION

1. Field of the Invention

The present invention relates to recording and playback of multimedia content. More particularly, this invention relates to central file storage systems comprising an array of disk drives that store multimedia content for delivery to newsroom clients at high data rates.

2. Description of the Background Art

The modern-day television broadcast news industry employs specialized computer systems to produce, promote and distribute multimedia content to clients within a newsroom (hereinafter “newsroom client” or “NZRM”). An overview of a typical computer system employed in the television broadcast news industry is described in U.S. Pat. No. 6,141,007, the disclosure of which is hereby incorporated by reference herein.

Important to the distribution of multimedia content, particularly High Definition (HD) video, is the ability to deliver the content to the newsroom clients upon demand at high data rates. Representative systems for newsroom clients employ large RAID servers for storage of multimedia content (representative systems are sold by Harris, Omneon, The Grass Valley Group (e.g., TM “Profile” and “K2”), Playbox.TV, AVID and Digital Broadcast). Unfortunately, however, implementation of these high-data-rate RAID multimedia servers require substantial capital investments.

Scalable multimedia servers are described in Scalable Storage Servers for Digital Audio and Video, by P Lougher, D Pegler and D Shepherd published at http://citeseerx.ist.psu.edu/viewdoc/download?doi=10.1.1.51.3266&rep=rep1&type=pdf and Scalability Issues for Mass Multimedia Storage Systems by D Pegler, D Hutchison and D Shepherd published at http://citeseerx.ist.psu.edu/viewdoc/download?doi=10.1.1.52.7093&rep=rep1&type=pdf, the disclosures of which are hereby incorporated by reference herein. As described in Scalable Storage Servers for Digital Audio and Video, one approach to load balancing is file/server replication. In this method, each server instance holds an identical copy of all the other instances' files. Each file held by a server is stored in its entirety. A client, when requesting service, is simply connected to the nearest or currently least loaded server, which replays the requested file without interaction from the other server instances. The total number of simultaneous stream replays in the system scales linearly with the number of server instances; if each server can replay x streams simultaneously, and if there are n server instances, then the total number of streams possible is n*x. The total number of stream replays for file replication and network striping is thus identical. The total disk capacity of the system remains static as n increases because each server must hold an exact copy of all the information within the system.

The present invention represents a substantial and economical improvement to load balancing by providing segmentation of multimedia content for storage on each of a plurality of low-cost disk drives of a single server and assigning each newsroom client to only one of such disk drives such that each newsroom client may pull multimedia content only from its designated disk drive.

### SUMMARY OF THE INVENTION

For the purpose of summarizing this invention, this invention comprises a system and method employing an array of economical disk drives that store multimedia content for on-demand delivery to newsroom clients at high data rates. More particularly, to capitalize on the lower cost of lower data-rate disk drives, the invention employs a single server having a plurality of the low-cost, low-data-rate disk drives in an array, with each disk drive containing identical copies of the multimedia content. The invention further employs a separate communication channel for each low-cost, low-data-rate disk drive. The newsroom clients are assigned to groups, the number of groups corresponding to the number of disk drives such that each group of newsroom clients is serviced by its respective disk drive over the respective communication channel. For example, for a server having 4 disk drives servicing a newsroom containing 20 newsroom clients, the 20 newsroom client may be divided into 4 groups of 5 newsrooms, with each of 4 groups being serviced by its respective disk drive over its respective communication channel. Further, to more evenly distribute demands for multimedia content over the communication channels from their respective disk drives, the newsroom clients that are most likely to demand multimedia content at the same time may be placed in different groups.

Additional disk drives with their respective communication channel may be provided for other groups of devices such as for a group of video recorders or a group of players.

The method of the invention (herein referred to as the Greeter Process) parcels the multimedia content (e.g., a multimedia stream or a file containing multimedia content). In a first embodiment of the Greeter Process, the multimedia content is parceled into data blocks having a size that is equal to the data field size of the drive's sectors. The Greeter Process then writes the parceled data block at least contemporaneously if not simultaneously to each of the disk drives, thereby optimizing the writing of the parceled content into the sectors of the disk drive and the subsequent reading of the parceled content from its sectors.

In a second embodiment, the Greeter Process parcels the multimedia content based upon inherent natural breaks such as anticipated periods intensive computation. For example, in the case of parceling an MPEG-2 data stream or file, the parceling may be based upon the inherent natural breaks such as the computationally heavy period at the end of each Group Of Pictures (GOP). In this embodiment, each parceled data block may be less in size than the data field size of the disk drive.

In a third embodiment, the Greeter Process parcels the multimedia content based upon a combination of the first and second embodiments described above. However, it is understood that the larger the data field size of the disk drive, the less desirable the second embodiment becomes because of the potential of not using (and hence wasting) too much space within the data fields on the disk drive.

Preferably, as each data block is parceled from the multimedia content, it is then written to the disk drives at least contemporaneously if not simultaneously in parallel. However, in the case of multimedia content that comprises a file, the file may alternatively be parceled in its entirety into data blocks whereupon each parceled block may then subsequently be written, at least contemporaneously if not simultaneously in parallel, to each of the disk drives.

In this regard, it is noted that in conventional disk drives, each sector includes the sector header (gap, synch byte and address mark) and the Error Correcting Code (ECC) in addition to the sectors' data field; hence the physical size of each of the sectors is greater than the size of the data field. For example, when employing magnetic disk drives that are low-level formatted at a conventional sector size of 512 bytes and sector header and ECC of 50 bytes, each sector is equal to 562 bytes.

Without departing from the spirit and scope of the invention, in one embodiment of the Greeter Process, multimedia content is parceled into 2,048 byte data blocks when employing optical disk drives that conventionally include 2,048 byte data fields. As another example, the Greeter Process may parcel the content into 4,096 byte data blocks when employing the more modern magnetic disk drives that are low-level formatted at 4,096 byte sectors (known as Advanced Format) in which eight 512 byte data fields are combined in a single data field (and the sector header and ECC fields are increased from 50 to 100 bytes) or when employing other less-common formats such as the Advanced Format 512e having 4,096 byte sectors with 512 byte firmware that accommodates legacy computing components such as chipsets, operating systems, database engines, hard drive partitioning and imaging tools, backup and file system utilities as well as software applications. For multimedia content, the disk drives are preferably formatted at the widest data field available (e.g., a 16K byte sector or a 64K byte sector).

In short, the Greeter Process may parcel the multimedia content into data blocks equal in size to the data fields of whatever the disk drive being employed is formatted to accommodate data, may parcel the multimedia content based upon natural breaks in the content, or a combination thereof.

In addition to writing the data to the disk drives in the desired data block sizes, the Greeter Process receives the multimedia content from a newsroom client or from a system video recorder, parcels it as described above into the appropriate data block size depending on the disk drives being employed or depending on natural beaks in the multimedia, or a combination thereof, and then writes each data block to each of the disk drives over their respective communication channel, one data block at a time.

Upon demand, the newsroom clients may read the desired multimedia content from its respective disk drive over its respective communication channel. Inasmuch as the multimedia content is identical on each disk drive, when any of the newsroom clients desires a particular multimedia file of, for example, a news event, each client receives an identical copy of that file of that news event over their respective communication channel from their respective disk drive.

In this regard, the disk drives employed preferably have lower data rates (e.g., 25 MB/s) at a substantially lower cost than higher data rate drives (e.g., SATA rev 1 drives having 150 MB/s, SATA rev 2 drives having 300 MB/s or SATA rev 3 drives having 600 MB/s). Nevertheless, the low-cost, low-data-rate drive are more than adequate when implementing the invention to deliver the multimedia content at a data rate needed for HD and other multimedia content because the multimedia content had been written to them in optimized data block sizes. It is further noted that employing separate communication channels according to the invention, such as separate subnets, for each disk drive assures that the content read from the drives will be delivered to the newsroom at the data rate needed for HD without bottlenecking

Without departing from the spirit and scope of this invention, the Greeter Process may be employed in computer software, firmware or hardware, or a combination thereof.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures and methods for carrying out the same purposes of the present invention. It should also be realized by those skilled in the art that such equivalent constructions and methods do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a block diagram of the system of the invention; and

FIG. 2 is a software flow diagram of the invention.

Similar reference characters refer to similar parts throughout the several views of the drawings.

### DETAILED DESCRIPTION OF THE PREFERRED EMBODIMENT

The following description is of the best mode presently contemplated for carrying out the invention. This description is not to be taken in a limiting sense, but is made merely for the purpose of describing one or more preferred embodiments of the invention. The scope of the invention should be determined with reference to the claims.

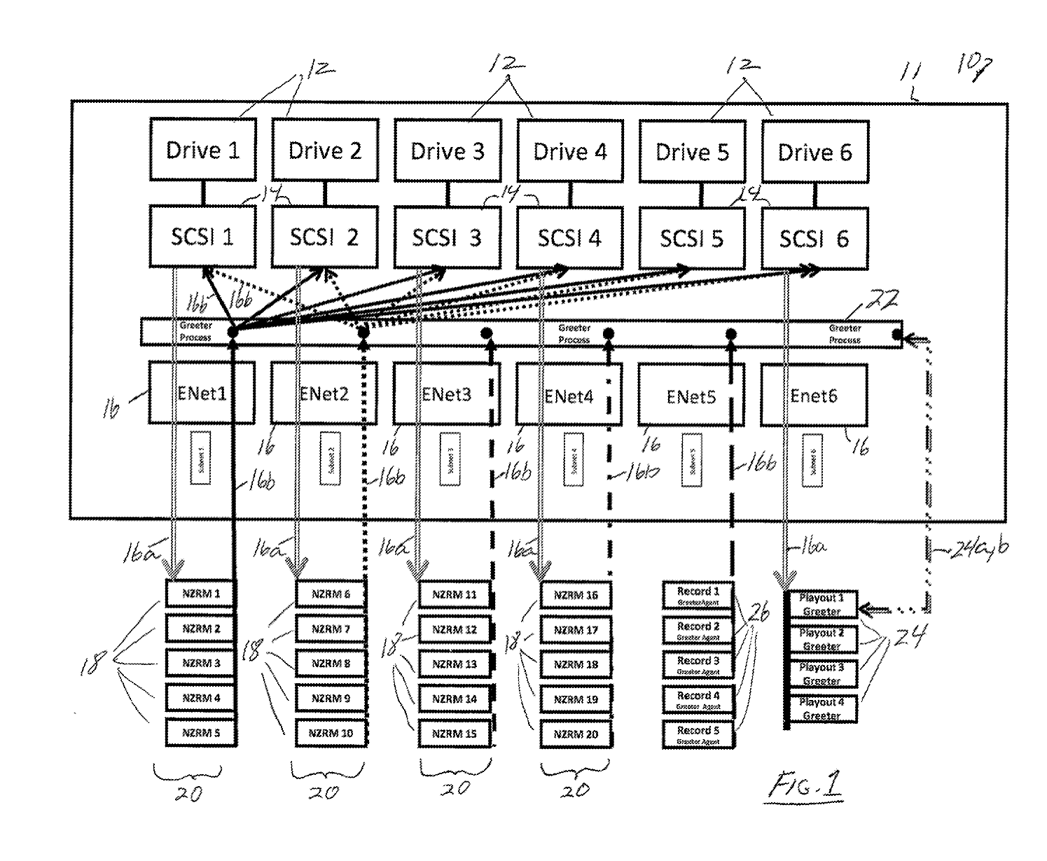

Referring to FIG. 1, the system 10 of the invention comprises a single server 11 including an array of disk drives 12, an interface 14 associated with each one of such disk drives 12 and a data flow channel 16 associated with each one of such interfaces 14 allowing data transfer from each disk drive 12 via their respective interface 14 over their respective data transfer channel 16.

Disk drives 12 may comprise magnetic or optical disk drives whose memory is low-level formatted into data fields such as but not limited to 512 byte, 2,048 byte or 4,096 byte data fields. More preferably, each disk drive 12 comprises a low-cost disk drive 12. It is noted that because the disk drives 12 are preferably lower cost drives, they innately have a significantly lower data transfer rate than that of more expensive drives. However, the system and method of the invention 10 nevertheless achieves an adequate data transfer rate despite the use of lower-cost/lower-transfer rate disk drives 12.

Interfaces 14 may each comprise a conventional Small Computer System Interface (“SCSI”) 14 such as but not limited to those more specifically known as parallel SCSI a/k/a SPI, Serial Attached SCSI a/k/a SAS or iSCSI that uses TCP/IP as a transport mechanism or other suitable interfaces such as but not limited to Serial Advanced Technology Attachment (“SATA”) or its revisions. As in the case of the disk drives 12, the interfaces 14 preferably comprise low-cost interfaces. While the low-cost interfaces 14 innately have lower data transfer rates than that of more expensive interfaces, the system and method of the invention 10 nevertheless achieves an adequate data transfer rate despite the use of lower-cost/lower-transfer rate interfaces 14.

Communication channels 16 may each comprise a subnet of a conventional 10BASE-T, 100BASE-TX or 1000BASE-T Ethernet network having data transfer rates of 10 Mbit/s, 100 Mbit/s, and 1 Gbit/s, respectively. It is noted that the data transfer rate of the most-common subnet (i.e., 100BASE-TX), significantly exceeds those of the low-cost disk drives 12 and interfaces 14.

Still referring to FIG. 1, a plurality of newsroom clients (“NZRM”) 18 are divided into groups 20, each group 20 containing of a small number of newsroom clients 18. Each group 20 is connected to its respective communication channel 16 so the newsroom clients 18 within one group 20 may pull multimedia content from only its respective disk drive 12. For example, as shown in FIG. 1, for a server 11 having four disk drives servicing a newsroom containing twenty newsroom clients 18, the twenty newsroom clients 18 may be divided into four groups 20 of five newsroom clients 18, with each of four groups 20 being serviced by its respective disk drive 12 via the respective interface 14 over its respective communication channel 16. Further, to more evenly distribute demands for multimedia content over the communication channels 16 from their respective disk drives/interfaces 12, 14, the newsroom clients 18 that are most likely to demand multimedia content at the same time are preferably assigned to different groups 20.

A Greeter Process 22 running on the server 11 functions to push multimedia content from any one of the newsroom clients 18 via the respective communication channel 16 onto each of the disk drives 12, preferably one data block at a time. Note that in FIG. 1, the “a” suffix of the communication channel 16 refers to the pull paths for pulling content from each of the disk drives 12 whereas the “b” suffix refers to the push paths for pushing content from the newsroom clients 18 onto each of the disk drives 12. Preferably, the content is pushed contemporaneously if not simultaneously in parallel via paths 16b onto each of the disk drives 12. Note also that for the sake of clarity in FIG. 1, only the fan-out push paths 16b of the communication channels 16 from ENet1 and ENet2 are shown; it being understood that similar fan-out push paths 16b are provided for the remaining communication channels 16, namely, ENet3 and ENet4, to each of the disk drives 12.

The system 10 of the invention further comprises a plurality of Playout engines 24. A similar disk drive 12 having the identical content pushed out to it via its respective interface 14 and communication channel 16a as the other disk drives 12, is associated with the Playout engines 24. The Greeter Process 22 consults the newsroom computer system as represented by path 24a,b to decide if a copy of the content should be made on the Playout engines 24 and if so, such content is pulled from the respective disk drive 12.

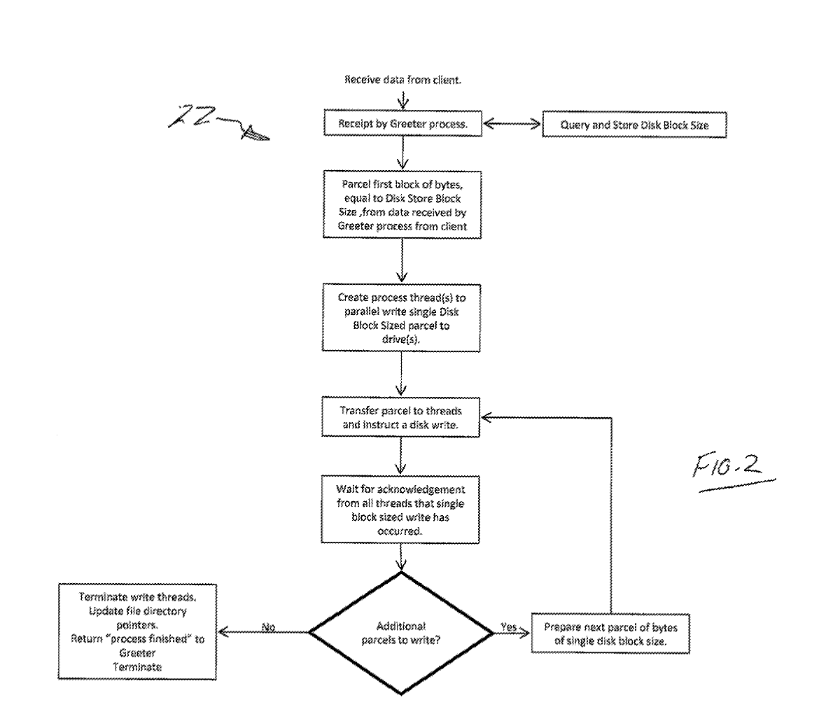

Preferably, each of the disk drives 12 are low-level formatted to have data fields of the same size such as but not limited to 512 bytes (or of the same virtual 512 byte size as in the case of Advanced Format 512e). Most preferably, the disk drives 12 sectors are low-level formatted as widely as possible such as at 4,096 byte blocks. As shown in the flowchart of FIG. 2, Greeter Process 22 parcels the first data block to equal the data field size of the disk drives 12 whereupon process threads are created to write, preferably in parallel, the data block to each of the disk drives 12. After receiving an acknowledgement that the write has occurred, the Greeter Process 22 then parallel writes the next data block. Parallel writing of successive data block occurs sequentially until all of the data blocks have been written, whereupon the threads are terminated and the file directory pointers are updated accordingly.

Returning to FIG. 1, the invention 10 further comprises a recorder operation that allow content from a plurality of recorders 26 to be pushed to each of the disk drives 12. When a write to one of the recorders 26 takes place, a Greeter Agent copies the content and, when a data block has been assembled equal to the data field size of the disk drive 12, the Greeter Agent transfers that data block to the Greeter Process 22 whereupon it is pushed onto each of the disk drives 12 via its communication channel 16 (ENet 5)(note that the fan-out paths from ENet 5 to each of the disk drives 12 is not shown in FIG. 1 for the sake of clarity but it is understood that fan-out push paths 16b from ENet5 to each of the disk drives 12 do in fact exist). Noteably, the Greeter Process 22 processes the data block in the same way as it processes the data blocks from the newsroom clients 18.

Importantly, the invention 10 maximizes a particular newsroom client 18 (or a particular Player 24) pulling of content from their respective drives 12 without interfering with drive access across any other drive 12. The invention 10 is therefore particularly suited for newsroom environments which seek to maximize the pulling of content from the data store over pushing content into the data store.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A system and method for recording and playback of multimedia content, comprises the steps of:
providing a plurality of disk drives in a single server, each disk drive containing identical copies of the multimedia content;
providing a separate interface for each disk drive;
providing a separate communication channel for the separate interfaces;
grouping a plurality of newsroom clients or recorders into a plurality of groups;
associating each of the groups with a respective communication channel and disk drives; and
when one of the newsroom client or recorders desires to pull the multimedia content, the copy of the multimedia content that is stored on the respective disk drive associated with the group containing the newsroom client or recorder, is pulled therefrom via the respective interface and transferred over the respective communication channel to such newsroom client or recorder.
